(19) United States
(12) Patent Application Publication
(10) Pub. No.: US 2014/0326343 A1
(43) Pub. Date: Nov. 6, 2014

(54) ELECTRICALLY DRIVABLE VALVE FOR REGULATING VOLUME FLOWS IN A HEATING AND/OR COOLING SYSTEM OF A MOTOR VEHICLE

(71) Applicant: Behr Thermot-tronik GmbH, Kornwestheim (DE)

(72) Inventor: Hans-Peter KLEIN, Leutenbach (DE)

(73) Assignee: Behr Thermot-tronik GmbH, Kornwestheim (DE)

(21) Appl. No.: 14/255,250

(22) Filed: Apr. 17, 2014

(30) Foreign Application Priority Data
May 3, 2013 (DE) 10 2013 208 193.6

(51) Int. Cl. F16K 11/02

(52) U.S. Cl. CPC F16K 11/02
USPC 137/625.46

(57) ABSTRACT

An electrically drivable valve for regulating volume flows in a heating and/or cooling system of a motor vehicle with a housing, on which at least two connecting pieces are formed, whereby depending on the arrangement of the valve in a heating and/or cooling circuit one or more connecting pieces are formed as inflow connections and a connecting piece as an outflow connection or one or more connecting pieces as outflow connections and a connecting piece as an inflow connection, whereby a valve body rotatable around a rotation axis is arranged in the housing. In the case of an electrically controllable valve, in which pressure losses in the control circuit are reliably reduced, in the case of an axial inflow or outflow of the valve by a heating medium and/or coolant the axes of one or more outflow connections or of one or more inflow connections are oriented axially and radially relative to the rotation axis of the valve body.

This nonprovisional application claims priority under 35 U.S.C. §119(a) to German Patent Application No. 10 2013 208 193.6, which was filed in Germany on May 3, 2013, and which is herein incorporated by reference.

### BACKGROUND OF THE INVENTION

1. Field of the Invention

The invention relates to an electrically drivable valve for regulating volume flows in a heating and/or cooling system of a motor vehicle.

2. Description of the Background Art

Thermal management in a cooling system plays a major role in today's motor vehicles, particularly with respect to reducing fuel consumption, reducing CO₂ emissions, and increasing comfort. In this regard, fluid flows are switched or regulated depending on the thermal requirement, thus, e.g., in the case of coolant stoppage during warm-up or according to the load conditions of the internal combustion engine. Electrically drivable valves with highly different design types are employed for switching and regulating the fluid flows.

DE 10 2006 053 310 A1 discloses a valve with a disk-shaped valve body, which has rotation angle-dependent opening characteristics for regulating the fluid flow volume. The inflow and outflow of the coolant occurs here axially to the rotation axis.

EP 0 639 736, which corresponds to U.S. Pat. No. 5,529,026, discloses a rotary valve, however, in which the inflow and outflow of the coolant occurs radially to the rotation axis. In this case, the outer contour of the valve body is used for rotation angle-dependent opening characteristics.

EP 1 108 867 A2 has a valve body with a number of perforations, whereby the valve body is designed as also open toward the surface.

DE 198 49 492 A1, which corresponds to US 20010042525, in contrast discloses a rotary valve in which the inflow occurs axially and the outflows of the coolant radially or vice versa,

The different valves in these cases have cylindrical or spherical valve bodies, which regulate the fluid volume flows by their outer contour or by their inner contour (holes, openings).

Depending on the structural design of the valve, pressure losses arise within the control circuit.

### SUMMARY OF THE INVENTION

It is therefore an object of the invention to provide an electrically drivable valve for regulating volume flows in a heating and/or cooling system of a motor vehicle, said valve which assures a reliable reduction of pressure losses in the control circuit.

This is attained in an embodiment, according to which in the case of an axial inflow or outflow of the valve by a heating medium and/or coolant, the axes of one or more outflow connections or of one or more inflow connections are oriented axially and radially relative to the rotation axis of the valve body. A pressure loss reduction is achieved by this design compared with valves with radial inflow and outflow or with axial inflow and one or more radial outflows. A better minimum amount regulation is possible at the same time.

In an embodiment, an axis of an outflow connection or inflow connection is the rotation axis, which lies in a first plane, and the respective other axis runs in a second plane, whereby the second plane is rotated around the rotation axis by a first angle a relative to the first plane, and whereby the respective other axis is inclined at an angle b relative to the rotation axis, whereby a is preferably between 15° and 165° and b preferably between 15° and 75°. The use of such a valve reduces the pressure loss within the control circuit.

In an embodiment, the axes of the outflow connection or the axis of the inflow connection and/or the rotation axis of the valve body do not have a common point of intersection. It is advantageous in this case that the axes of the individual connections can each have individually different first and second angles.

In an embodiment, the axis of one or more inflow connections can be formed between an axial or radial orientation and the axis of the outflow connection radially to the rotation axis of the valve body or the axis of one or more outflow connections is formed between an axial or radial orientation and the axis of the inflow connection radially to the rotation axis of the valve body.

Alternatively, the axes of the inflow connections and the outflow connection or the axes of the outflow connections and the inflow connection can be arranged between an axial or radial orientation.

In a further embodiment, the axis of an inflow connection and the axis of the outflow connection are formed axially to the rotation axis of the valve body and the axis of the further inflow connections radially to the rotation axis of the valve body, or the axis of an outflow connection and the axis of the inflow connection are arranged axially to the rotation axis and the axis of the further outflow connections radially to the rotation axis of the valve body. The structurally different embodiments of the connections result in many possibilities for reducing pressure losses in the control circuit.

In an embodiment, the valve body is variable pivotably relative to the rotation axis. Because according to the specification by a control device the valve body changes its rotation angle pivotably, only a small installation space is needed for the valve body, as a result of which the size of the valve can also be reduced. By means of this pivotable movement, the valve body can be used for a variety of housing designs of the valve with differently arranged inflow and outflow connections.

The valve body can be formed like a hemisphere or spherical segment. Such valve bodies are easily movable within the valve and can be brought into any position in order to open or close the desired inflow or outflow fittings of the valve. In such a hemisphere-like valve body, the rotation axis passes through the apex of the valve body. It is also conceivable as an alternative, however, that the rotation axis has an angle to the apex of preferably up to 30°.

A valve thus formed is therefore feasible in the heating medium and/or coolant circuit both as an ingress regulator for the coolant for the internal combustion engine or also as an egress regulator of the heated fluid from the internal combustion engine.

In an embodiment, the valve body assumes at least two switching states. The switching states thereby realize an open or a closed outflow or inflow connection. A very simple regulation of the coolant is provided by such a control of the electromotively actuated valve body.

A substantially finer regulation of the coolant is possible, if the valve body assumes, preferably continuously variably, a plurality of switching states. In this regard, any intermediate states between the open and closed state of an outflow or inflow connection are provided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a to 1d illustrate exemplary embodiments for the inflow/outflow of the fluid in a valve body, formed as a spherical segment, of the valve;

FIGS. 2a to 2c are schematic diagrams of possible arrangements of the inflow or outflow fittings of the valve according to FIG. 1;

FIGS. 3a to 3f illustrate examples of the inflows/outflows of the coolant using the example of the valve according to FIG. 1.

### DETAILED DESCRIPTION

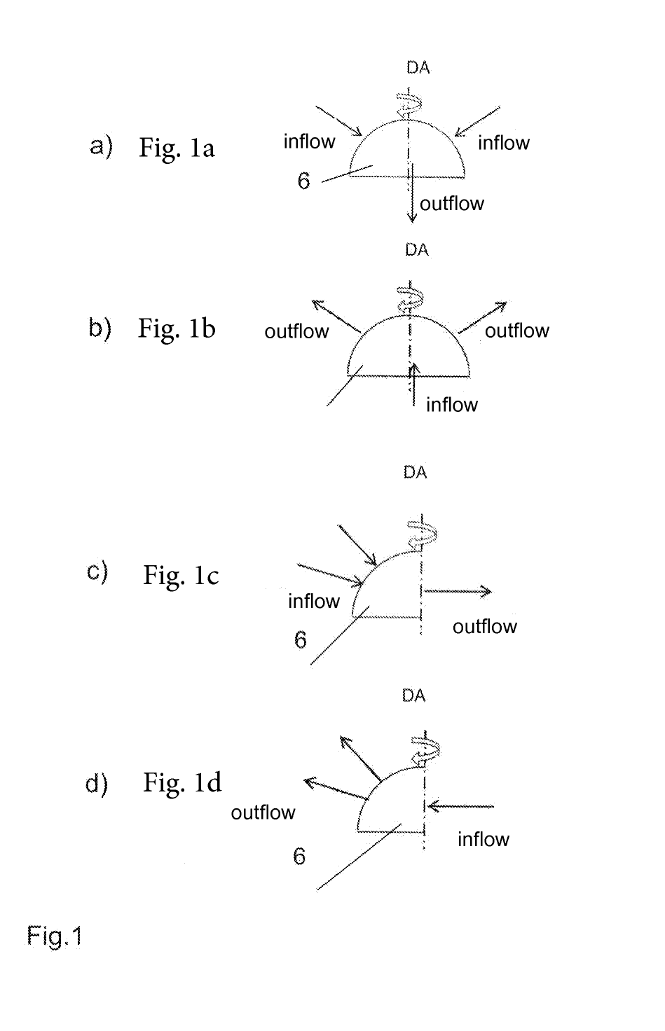

The inflows/outflows in a hemispherical valve body 6 are shown schematically in FIGS. 1a and 1b. In FIG. 1a, the connecting piece for the inflow is arranged between an axial and radial orientation relative to the rotation axis DA of valve body 6, whereas the connecting piece provided for the outflow is formed axially to the rotation axis DA of the valve body. This mode of action is realized in a valve as an ingress regulator. In the design of the valve as an egress regulator, an axial inflow occurs through the one connecting piece, whereas the further connecting pieces are formed as outflow fittings, which are also formed between an axial and radial orientation to the rotation axis DA (FIG. 1b).

In FIG. 1c, valve body 6 is formed as a spherical segment, for example, as a quadrant of a hemisphere. In this regard, the inflow fittings used for the inflow are located next to one another on a valve housing area adjacent to the spherical segment, formed as a quadrant of a hemisphere, of the valve body, whereby the axes of these connecting pieces are formed between a radial and axial orientation to the rotation axis DA. The outflow, which occurs here through the connecting piece, occurs radially to the rotation axis DA. The embodiment shown here also corresponds to an ingress regulator. The structure in the case of a valve used as an egress regulator is made clear in FIG. 1d, where the two connecting pieces used for outflow are also arranged with their axes next to one another on a valve housing area, opposite to the spherical segment, formed as a quadrant of a hemisphere, of valve body 6 and thereby have an orientation between radial and axial to the rotation axis DA. The axis of the connecting piece for inflow is arranged radially to the rotation axis DA on the opposite side of the spherical segment.

Valve body 6 can be designed in a different fashion. It can have one or more holes through which the volume flow of the fluid flowing through the valve is regulated. Instead or in addition to the holes, one or more recesses can be present. Valve body 6 can be made open or closed on its front side and be produced from an injection-moldable plastic. Valve body 6 has a layer of sealing material on its surface, preferably on its outside. Said layer is covered by a further layer with a smooth and therefore friction-reducing material. Alternatively, one of more molded seals can applied to its surface.

Raised areas or recesses that do not penetrate through valve body 6 can be formed on the surface of valve body 6. Valve body 6 in this regard is blown onto a shaft preferably formed of steel, whereby the shaft can have shaft ends, which are also injection molded. Alternatively, there is the possibility that an at least partially continuous shaft is present, on which valve body 6 is placed axially displaceable. There can be an outer contour or an inner contour, which represents a form-fitting connection to an electrical drive, on the shaft.

Valve body 6 can be brought under preloading against one or more openings of the connecting pieces by resilient or other mechanical devices. Due to this preloading valve body 6 can execute an adjusting movement in the case of wearing seals in order not to exceed a specified leakage over the valve's lifetime.

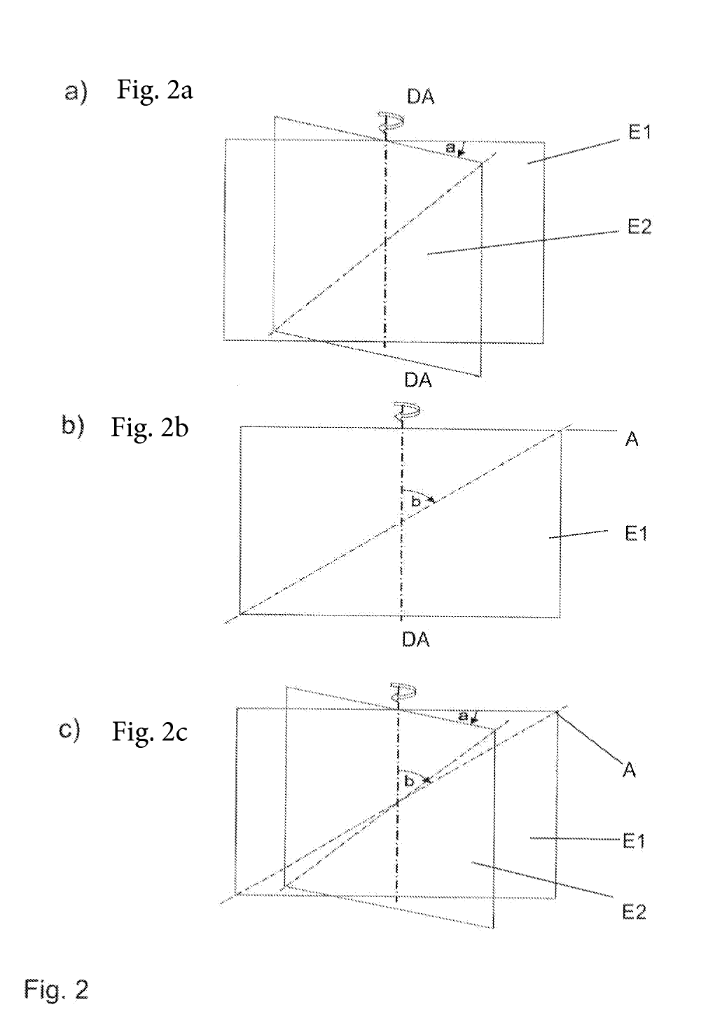

According to FIG. 2b, the axis A of each connecting piece formed as an inflow connection lies in a first plane E1 at an angle b of 15° to 75° to the rotation axis DA of valve body 6 and in a second plane E2, which is at a second angle a between 15° and 165° to plane E1 (FIG. 2a). The axes A of the connecting pieces can each have angles a and b different per se, as is shown in FIG. 2c. In this case, they need not necessarily intersect with rotation axis DA or with one another.

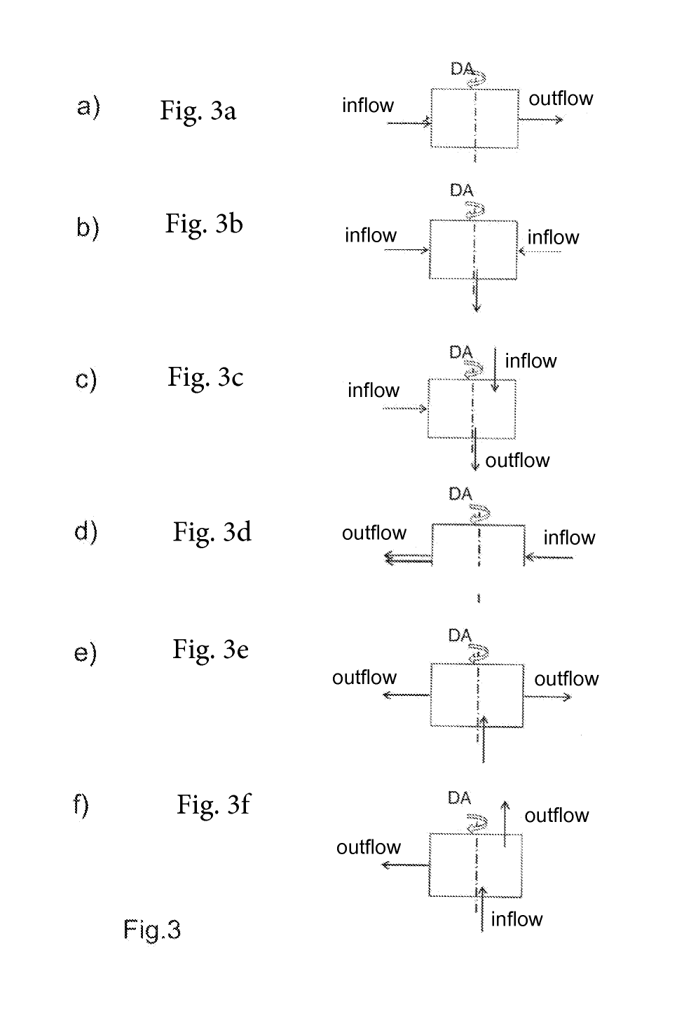

Different possibilities for the inflow or outflow are shown in FIG. 3 using the example of a valve with three connecting pieces. In this case, one outflow and two inflows are considered in FIGS. 3a, 3b, and 3c. The valve is used as an ingress regulator. If two outflows and only one inflow of the valve used as the egress regulator are present, as is shown in FIGS. 3d, 3e, and 3f, similar relationships arise. Therefore only the flow relationships at the ingress regulator are considered hereafter.

According to FIG. 3a, the inflow of the valve occurs via the two connecting pieces radially to the rotation axis DA, whereas the outflow of the valve occurs through the connecting piece also radially to the rotation axis DA. FIG. 3b shows that an inflow through a first connecting piece and a second inflow through the second connecting piece occurs in each case radially to the rotation axis DA but in opposite directions to one another, whereas the outflow from the valve is carried out axially to the rotation axis DA. In FIG. 3c, an inflow and outflow through the connecting pieces occur axially to the rotation axis, whereas an inflow of the valve occurs through the connecting piece radially to the rotation axis DA.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrically drivable valve for regulating volume flows in a heating and/or cooling system of a motor vehicle, the valve comprising:
a housing on which at least two connecting pieces are formed, wherein based on an arrangement of the valve in a heating and/or cooling circuit, one or more connecting pieces are formed as inflow connections and a connecting piece as an outflow connection or one or more connecting pieces as outflow connections and a connecting piece as an inflow connection; and
a valve body rotatable around a rotation axis and being arranged in the housing;
wherein, in a case of an axial inflow or outflow of the valve by a heating medium and/or coolant, axes of one or more outflow connections or of one or more inflow connections are oriented axially and radially relative to the rotation axis of the valve body.

2. The valve according to claim 1, wherein an axis of an outflow connection or an inflow connection is the rotation axis, which lies in a first plane and a respective other axis runs in a second plane, wherein the second plane is rotated around the rotation axis by a first angle relative to the first plane, wherein the respective other axis is inclined at an second angle relative to the rotation axis, and wherein the first angle is between 15° and 165° and the second angle is between 15° and 75°.

3. The valve according to claim 2, wherein the axes of the outflow connections and the axis of the inflow connection and/or the rotation axis of the valve body do not have a common point of intersection.

4. The valve according to claim 1, wherein the axis of one or more inflow connections is formed between an axial or radial orientation and the axis of the outflow connection radially to the rotation axis of the valve body or the axis of one or more outflow connections is formed between an axial or radial orientation and the axis of the inflow connection radially to the rotation axis of the valve body.

5. The valve according to claim 1, wherein the axes of the inflow connections and the outflow connection or the axis of the outflow connections and the inflow connection are arranged disposed between an axial or radial orientation.

6. The valve according to claim 1, wherein the axis of an inflow connection and the axis of the outflow connection are formed axially to the rotation axis of the valve body and the axis of the further inflow connection radially to the rotation axis of the valve body, or wherein the axis of an outflow connection and the axis of the inflow connection are formed axially to the rotation axis and the axis of the further outflow connection radially to the rotation axis of the valve body.

7. The valve according to claim 1, wherein the valve body is variable pivotably relative to the rotation axis.

8. The valve according to claim 1, wherein the valve body is formed as a hemisphere or spherical segment.

9. The valve according to claim 1, wherein the valve body has at least two switching states.

10. The valve according to claim 1, wherein the valve body has a continuously and variably plurality of switching states.
